(19) United States
(12) Patent Application Publication
(10) Pub. No.: US 2017/0251546 A1
(43) Pub. Date: Aug. 31, 2017

(54) IGNITION DEVICE

(71) Applicant: IMAGINEERING, INC., Kobe-shi, Hyogo (JP)

(72) Inventors: Yuji Ikeda, Kobe-shi (JP); Seiji Kanbara, Kobe-shi (JP)

(73) Assignee: IMAGINEERING, INC., Kobe-shi, Hyogo (JP)

(21) Appl. No.: 15/325,267

(22) PCT Filed: Jul. 13, 2015
(86) PCT No.: PCT/JP2015/070083

§ 371 Date: Apr. 14, 2017

(30) Foreign Application Priority Data
Jul. 11, 2014 (JP) 2014-143648

(51) Int. Cl. H05H 1/52; F02M 57/06; F02P 23/04

(52) U.S. Cl. CPC H05H 1/52; F02P 23/045; F02M 57/06

(57) ABSTRACT

An ignition device is provided, which can boost an electromagnetic wave supplied by a resonance structure, and cause a discharge by enhancing a potential difference between a discharge electrode and a ground electrode, and even though such a structure of the ignition device, a downsize and a thickness reduction, specifically, the thickness reduction can be achieved. On a main surface of a rectangular insulting substrate (2), an input electrode (3), a coupling electrode (4), a discharge electrode (6), and a ground electrode (7), are provided. The input electrode (3) is connected to an outside terminal on one shorter side. The coupling electrode (4) is capacity-coupled with the input electrode (3). The discharge electrode (6) is connected to the coupling electrode (4) on the other shorter side through a coupling line (5). The ground electrode (7) is, on both longer sides of the main surface of the rectangular insulating substrate (2), capacity-coupled with the coupling electrode (4) and capacity-coupled with the coupling line (5), and extended to the other shorter side. A resonance circuit includes a capacitor constituted by the capacity coupling and an inductor constituted by the coupling line (5). Thereby, the electromagnetic wave supplied from the outside terminal into the input electrode is resonated, a potential difference between the discharge electrode (6) and the ground electrode (7) is enhanced, and then, a discharge is caused.

### TECHNICAL FIELD

The present invention relates to an ignition device of an internal combustion engine, specifically, an ignition device that ignites only by an electromagnetic wave.

### PRIOR ART

Conventionally, ignition devices using the plasma generation device that generates the electromagnetic wave plasma by irradiating the electromagnetic wave into the combustion chamber of internal combustion engine are suggested as ignition devices for ignition of the internal combustion engine. For example, in Japanese unexamined patent application publication No. 2009-38025, and in Japanese unexamined patent application publication No. 2006-132518, the ignition device of the internal combustion engine that uses such kind of plasma generation device is described.

In the Japanese unexamined patent application publication No. 2006-132518, the ignition device of the internal combustion engine that generates the plasma discharge by irradiating the electromagnetic wave into the combustion chamber from the electromagnetic wave emitter is disclosed. On the upper surface of piston, the electrode for ignition that is insulated from the piston is arranged. The electrode for ignition plays a role of enhancing locally the electromagnetic field strength of electromagnetic wave inside the combustion chamber in the neighborhood. Thereby, the plasma discharge is caused in the vicinity of the electrode for ignition. The plasma generation device generates plasma by using only electromagnetic wave, and therefore, only one electric power source is required; however, a large amount of electric power is required for being supplied from the high frequency wave power source in order to ignite and cause the combustion only by the electromagnetic wave. Further, separately, special work application is required on the piston for the need of the electrode for ignition on top surface of the piston.

In order to solve the above problem, inventors suggested the small-sized ignition device of the internal combustion engine that can efficiently generate, expand, and maintain the plasma by using only the electromagnetic wave without requiring the spark plug that discharges by the high voltage or complicated system, and etc. The ignition device integrally comprises the electromagnetic wave oscillator configured to oscillate the electromagnetic wave, the controller configured to control the electromagnetic wave oscillator, the boosting circuit including the resonance circuit which is capacity-coupled with the electromagnetic wave oscillator, and the discharge electrode configured to discharge the high voltage generated by the boosting circuit.

### PRIOR ART DOCUMENTS

### Patent Document(s)

Patent Document 1: Japanese unexamined patent application publication No. 2009-38025
Patent Document 2: Japanese unexamined patent application publication No. 2006-132518
Patent Document 3: Japanese unexamined patent application publication No. 2013-128007

### SUMMARY OF INVENTION

### Means to Solve the Problems

Regarding the above-mentioned ignition device, a plurality of ignition devices can be arranged in the combustion chamber of the internal combustion engine because of the small size; however, the shape is structurally cylindrical shape, and in order to mount to the internal combustion engine, desired mounting port provided with screw thread is required to be formed in the engine head. Moreover, in the application in which, for example, fuel of large sized-diesel engine truck at secondhand vehicle market is replaced to gaseous fuel, the igniter is required to be arranged in the vicinity of injector for the reason that self-ignition is difficult; however, there is problem that further downsize and reduction of thickness is necessary in order to arrange the ignition device without performing supplementary work to the engine head.

The present invention is made from the viewpoint of the above. The objective is to provide an ignition device that boosts an electromagnetic wave supplied by a resonance structure, enhances a potential difference between a discharge electrode and a ground electrode, and causes a discharge, and the ignition device of the present invention can be downsized, specifically reduction of thickness can be achieved.

A first invention for solving the above problems is an ignition device. The ignition device comprises a rectangular insulating substrate having a main surface, an input electrode provided on the main surface of the rectangular insulating substrate and connected to an outside terminal on one shorter side of the rectangular insulating substrate, a coupling electrode provided on the main surface of the rectangular insulating substrate and capacity-coupled with the input electrode, a discharge electrode provided on the main surface of the rectangular insulating substrate and connected to the coupling electrode on the other shorter side of the rectangular insulating substrate through a coupling line, and a ground electrode provided on the main surface of the rectangular insulating substrate and capacity-coupled with the coupling electrode and capacity-coupled with the coupling line on both longer sides of the rectangular insulating substrate, and extended to the other shorter side. The ignition device has a resonance circuit constituted by a capacitor formed by the capacity coupling and an inductor formed by the coupling line, is configured to resonate an electromagnetic wave that is supplied from the outside terminal into the input electrode, and is configured to cause a discharge by enhancing a potential difference between the discharge electrode and the ground electrode.

The ignition device of the present invention forms the resonance circuit including the capacitor and the inductor on the main surface of the insulating substrate, for example, a ceramic substrate such as, for example, alumina. The capacitor and the inductor are constituted of a pattern of the coupling electrode, the coupling line, the discharge electrode, and the ground electrode that are formed by a conductive paste mainly composed of a metal powder material such as tungsten. The electromagnetic wave supplied from the outside terminal connected to the input electrode on one shorter side (end surface) of the insulating substrate, is resonated to boost, and the discharge can be caused between the discharge electrode and the ground electrode on the other shorter side (end surface). In this manner, the thickness-reduced insulating substrate functions as the ignition device, and thereby, an arranging position of the ignition device to an internal combustion engine can significantly freely be selected, i.e., a selection range can be expanded, and building the ignition device in a tip end of an injector or intake-exhaust valves or gasket can be performed.

A second invention for solving the above problems is an ignition device. The ignition device comprises at least one first rectangular insulating substrate, at least one second rectangular insulating substrate, and at least one third rectangular insulating substrate, which are laminated one another, the first rectangular insulating substrate has a main surface on which an input electrode is connected to an outside terminal on one shorter side of the first rectangular insulating substrate, the second rectangular insulating substrate having a main surface on which a coupling electrode, a discharge electrode, and a ground electrode for discharge are provided, the coupling electrode being capacity-coupled with the input electrode, the discharge electrode being connected to the coupling electrode on the other shorter side of the second rectangular insulating substrate through a coupling line, and the ground electrode for discharge being arranged in a vicinity of the discharge electrode on the other shorter side, and the third rectangular insulating substrate having a main surface on which a ground electrode is capacity-coupled with the coupling electrode and capacity-coupled with the coupling line, and jointed with the ground electrode for discharge through a via for an interlayer connection. The ignition device has a resonance circuit constituted by a capacitor formed by the capacity coupling and an inductor formed by the coupling line, is configured to resonate an electromagnetic wave that is supplied from the outside terminal into the input electrode, and is configured to cause the discharge by enhancing a potential difference between the discharge electrode and the ground electrode.

In the ignition device of the present invention, the capacity coupling between the coupling electrode and the ground electrode, and the capacity coupling between the coupling line and the ground electrode, are performed between interlayer. Therefore, compared to a case where the capacity couplings are performed on the same main surface, the discharge that may be caused between the capacity-couplings can be prevented.

In these cases, a notched portion in the substrate between the discharge electrode and the ground electrode on the other shorter side can be formed. Thereby, a sufficient discharge space can be secured between the discharge electrode and the ground electrode.

Further, in the ignition device according to the first invention, a plurality of said rectangular insulating substrates, each provided with the input electrode, the coupling electrode, the coupling line, the discharge electrode, and the ground electrode, can be laminated and configured such that a resonance frequency of each resonance circuit differs from one another. A plurality of ignition devices are laminated, which are constituted of the rectangular insulating substrates having different resonance frequencies respectively, and each input electrode is connected to one outside terminal. Thereby, even if there may be a fluctuation of the electromagnetic wave frequency of the electromagnetic wave oscillator connected to the outside terminal, supplied electromagnetic wave in any one of ignition devices is resonated, and the discharge is caused between the discharge electrode and the ground electrode. Furthermore, an interval of different resonance frequencies is preferably set to a half width or less than the half width. Thereby, the discharge can surely be caused, even if it is configured so as to become high Q factor.

In this case, the different resonance frequencies are caused by adjusting a length of the coupling line and a distance between the coupling line and the ground electrode. Further, a diode is arranged between the coupling line and the ground electrode, and the different resonance frequencies can be caused.

### Effect of Invention

An ignition device of the present invention boosts an electromagnetic wave supplied by a resonance structure, enhances a potential difference between a discharge electrode and a ground electrode, and causes a discharge. A downsize and a reduction of thickness of the ignition device can be achieved. Specifically, with regard to a ceramic substrate, manufacturing can be performed under a thickness of 200 μm or less than 200 μm, and therefore, even if a plural sheets of substrates are laminated, a thinned ignition device, i.e., about 1 mm, can be provided.

### SIMPLE EXPLANATION OF FIGURES

FIG. 1. illustrates an ignition device of a present first embodiment, (a) is a plan view of an insulating substrate that functions as the ignition device, (b) is a perspective view that illustrates a state before laminating the insulating substrate and a protective substrate, and (c) is a perspective view that illustrates a situation of laminating the insulating substrate and the protective substrate.

FIG. 2. illustrates an ignition device of a modification of the present first embodiment, (a) is a plan view of an insulating substrate that functions as the ignition device, (b) is a perspective view that illustrates the state before laminating the insulating substrate and the protective substrate, and (c) is a perspective view that illustrates the situation of laminating the insulating substrate and the protective substrate.

FIG. 3. illustrates a schematic view showing an example of which the ignition devices are mounted to intake exhaust valves of the internal combustion engine, (a) is a plan view, and (b) is a bottom view.

FIG. 4. illustrates the ignition device of a second embodiment, and is a perspective view that illustrates the state before laminating a plurality of insulating substrates and the protective substrate.

FIG. 5. illustrates an equivalent circuit that shows a boosting means of the ignition device.

FIG. 6. illustrates an ignition device of a third embodiment, (a) is a perspective view, (b) is a plan view, and (c) is a perspective view of a modification.

FIG. 7. illustrates a layer (electrode pattern) of each substrate, (a) shows a main surface of a first substrate, (b) shows a back surface of the first substrate, (c) shows the back surface of a third substrate, (d) shows the main surface of a fourth substrate, and (e) shows the back surface of the fourth substrate.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### FIRST EMBODIMENT

### Ignition Device

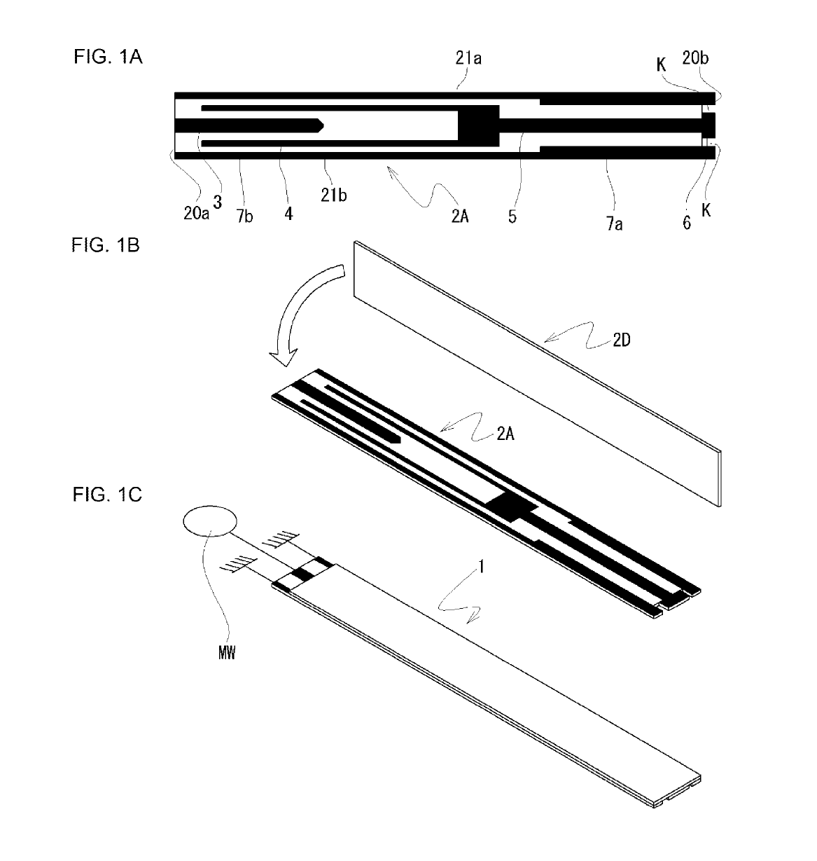

The first embodiment is an ignition device 1 regarding the present invention. The ignition device 1, as illustrated in FIG. 1, on a main surface of a rectangular insulating substrate 2A (in below, refers to “insulating substrate 2A”), includes an input electrode 3, a coupling electrode 4, a discharge electrode 6, and a ground electrode 7. The input electrode 3 is connected with an outside terminal at a shorter side 20a on one side of the substrate. The coupling electrode 4 is capacity-coupled with the input electrode 3. On the other shorter side 20b, the discharge electrode 6 is connected with the coupling electrode 4 via a coupling line 5. On both longer sides 21a and 2 b of the main surface of the insulating substrate 2A, the ground electrode 7 is provided, which is capacity-coupled with the coupling electrode 4 and capacity-coupled with the coupling line 5, and extended to the other shorter side 20b. Each electrode is formed in such a capacity-coupled resonance structure, and thereby, a boosting means for boosting an electromagnetic wave is constituted. Thereby, the ignition device 1 resonates an electromagnetic wave supplied into the input electrode from an electromagnetic wave oscillator MW via the outside terminal, the potential difference between the discharge electrode 6 and the ground electrode 7 is enhanced, and the discharge is caused.

The insulating substrate 2A of the ignition device 1 is formed by calcining powder of ceramics such as, for example, alumina (Al₂O₃), aluminum nitride, cordierite, mullite (in below, refers to “ceramic material”). In the present embodiment, a monolayer insulating substrate 2 made of ceramics is used for the ignition device 1. Specifically, a binder and solvent are added into ceramic material, mixed with and crushed, and uniformed slurry is manufactured. After then, obtained slurry is sprayed and dried so as to produce granulated powder. The granular is used to form a ceramics molded body with a desired shape by such as CIP (cold isotropic pressing), press-forming, or injection molding, and then calcined at a baking farness. CIP is a method in which the granular is thrown into a rubber die, and pressed by using water pressure, the press-forming is a method in which the granular is thrown into a mold and pressed, and the method is suitable for molding a small-sized plate like body, and most suitable method for molding an insulating substrate 2 in the present embodiment.

The input electrode 3, the coupling electrode 4, the coupling line 5, and the discharge electrode 6 are printed on the insulating substrate 2A through the method such as screen printing, by using a conductive paste that is mainly composed of metal powder material, for example, silver, copper, tungsten, molybdenum, and etc. which has a low electrical resistance, and the above structure (referring to FIG. 1(a)) is obtained.

The substrate between the discharge electrode 6 and the ground electrode 7 located at the other shorter side 20b is notched, and a notching portion K is preferably formed. By forming the notching portion K, a sufficient discharge space is formed between the discharge electrode 6 and the ground electrode 7. Then, the discharge between the discharge electrode 6 and the ground electrode 7 can surely be caused.

A protection substrate 2D is overlaid so as to cover an electrode surface of the insulating substrate 2A, and heat and pressure are applied to laminate. The protection substrate 2D is a little shorter than the insulating substrate 2A, the input electrode 3 and the ground electrode 7 of the insulating substrate 2A are partially exposed, the input electrode 3 is connected to the electromagnetic wave oscillator MW via the outside terminal (not illustrated), and the ground electrode 7 is earthed.

—Boosting Means—

The boosting means includes a resonance structure capacity-coupled with the electromagnetic wave oscillator MW configured to oscillate an electromagnetic wave, i.e., the input electrode 3. The resonance structure comprises a resonance circuit having a capacitor and an inductor. The capacitor is formed by a capacity coupling between the ground electrode 7 and the coupling electrode 4 and a capacity coupling between the ground electrode 7 and the coupling line 5. The inductor is formed by the coupling line.

The boosting means is constituted by adjusting each length such that C2 is sufficiently larger than C3 (C2>>C3). C2 is a resonance capacitance of a capacitor C2 that is constituted of the coupling electrode 4 and the ground electrode 7. C3 is a resonance capacitance of a capacitor C3 that is constituted of the coupling line 5 and the ground electrode 7. By adopting such a configuration, the electromagnetic wave is sufficiently boosted to become high voltage, and the discharge (breakdown) can be caused between the discharge electrode 6 and the ground electrode 7.

The resonance capacitance C2 is a grounding capacitance (stray capacitance) by the capacitor C2 formed by the coupling electrode 4 and the grounding electrode 7. The resonance capacitance C2 is determined by the length of the coupling electrode 4 in the longitudinal direction, distance between the coupling electrode 4 and the ground electrode 7, and dielectric constant of the insulating substrate 2A. Detailed length of the capacitor C2 part is designed such that the resonance is performed in accordance with the frequency of the electromagnetic wave (microwave) oscillated from the electromagnetic wave oscillator MW.

The resonance capacitance C3 is a capacitance at a discharge side (stray capacitance) of the capacitor C3 formed by the coupling line 5 and the ground electrode 7. The resonance capacitance C3 is determined by the length of the coupling line 5 in the longitudinal direction, distance between the coupling line 5 and the ground electrode 7, and the dielectric constant of the insulating electrode 2A. Specifically, it is preferable that the resonance capacitance C3 is decreased as much as possible, and the distance between the coupling line 5 and the ground electrode 7 is set larger. Further, the insulating substrate 2A between the coupling line 5 and the ground electrode 7 is notched. Thereby, the dielectric constant is lowered, and the resonance capacitance C3 can also be designed so as to be smaller.

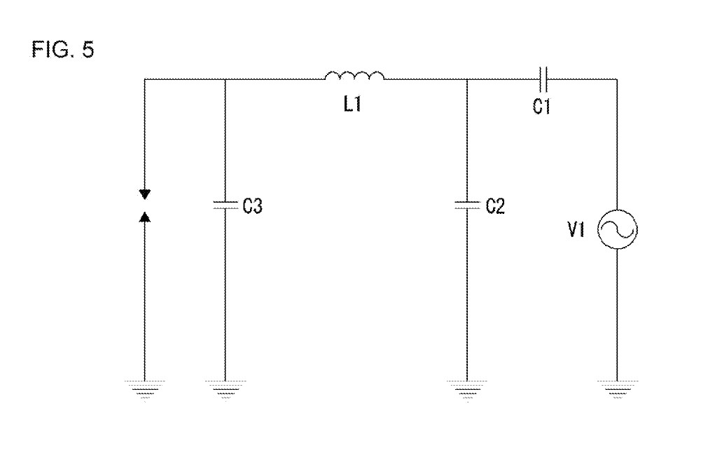

C1 in an equivalent circuit shown in FIG. 5 illustrates a capacity coupling portion between the input electrode 3 and the coupling electrode 4, and attains an impedance matching with the electromagnetic wave oscillator MW.

—Operation of Ignition Device—

The plasma generation operation (ignition operation) of the ignition device 1 is described. In the plasma generation operation, the discharge is caused by the potential difference between the discharge electrode 6 and the ground electrode 7, the plasma is generated in the vicinity of the discharge electrode 6 and the ground electrode 7 (discharger), and injected fuel is ignited.

The specific plasma generating operation (ignition operation) is as follows. Firstly, a controller (not illustrated) outputs an electromagnetic wave oscillating signal with a predetermined frequency f. The oscillating signal is outputted according to a crank angle of an internal combustion engine (generally, before a top dead center (BTDC) of a compression stroke). The electromagnetic wave oscillator MW that receives power supply from an electromagnetic wave source (not illustrated), when receives such an electromagnetic wave oscillating signal, outputs an electromagnetic wave pulse with a frequency fat a predetermined duty ratio over a predetermined set time. The electromagnetic wave pulse outputted from the electromagnetic wave oscillator MW becomes a high voltage by the boosting means of the ignition device 1 that has a resonance frequency f. The mechanism in which the electromagnetic wave becomes high voltage is achieved because, as described above, with regard to the resonance capacitances (stray capacitances) C2 and C3, it is configured such that C2 is sufficiently larger than C3, and it is also configured such that the resonance circuit is formed by the stray capacitance C3 between the coupling line 5 and the ground electrode 7, the stray capacitance C2 between the coupling electrode 4 and the ground electrode 7, and a coil corresponding to L1 of the equivalent circuit, the coupling line 5. Then, the boosted electromagnetic wave enhances the potential difference between the discharge electrode 6 and the ground electrode 7, the discharge is caused, and the spark is generated. By the spark, electrons are released from the gaseous molecules generated in the vicinity of the discharger, the plasma is generated, and the fuel is ignited. Note that, the electromagnetic wave oscillated from the electromagnetic wave oscillator MW may be a continuous wave (CW).

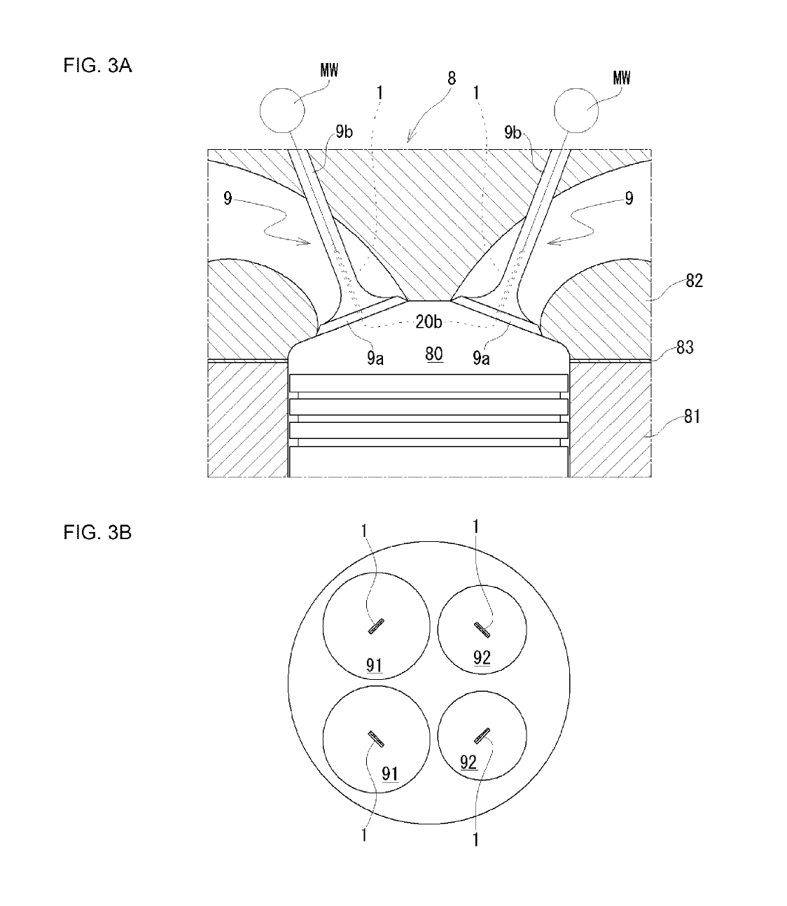

FIG. 3 illustrates an example of which the ignition device 1 is mounted to intake valves 91, and exhaust valves 92 of an internal combustion engine 8 (in below, if collected together, called solely for “poppet valve 9”). Specifically, the shorter sides 20b on which the discharge electrode 6 and the ground electrode 7 are formed, are arranged in the poppet valve 9 such that each shorter side 20b is positioned in the center of the surface of an umbrella part 9a of the poppet valve 9 that is exposed to the combustion chamber 80. Then, it is configured such that the electromagnetic wave oscillated from the electromagnetic wave oscillator MW is supplied into the input electrode 3 via a transmission line such as a coaxial cable existed inside a shaft part 9b. Accordingly, an ignition can be operated from four points toward one combustion chamber 80 of the internal combustion engine 8. Further, in the center of cylinder head 82, a spark plug that is used in a general gasoline engine can also be arranged.

Further, the ignition device 1 can be built in a gasket 83 arranged between the cylinder block 81 and the cylinder head 82. An arranging number of ignition devices 1 when built-in the gasket 83, is not especially limited; however, the ignition devices 1 are preferably arranged in multiple positions (four to eight positions) on a circumference of a bore at an equal interval. By building the ignition devices 1 in the gasket 83, fire seed for igniting fuel is generated on the outer circumference. Thereby, a flame propagation is directed from the outside to the inside, and a coldness loss can significantly be reduced (In a case of a general gasoline engine, a flame propagation is directed from the inside to the outside, the coldness loss from the cylinder wall surface increases, and it is a main factor of incapable of a heat efficiency).

### Effect of First Embodiment

The ignition device 1 of the present first embodiment boosts the electromagnetic wave and the discharge can be performed. Therefore, the outer diameter length of the device as a whole can significantly be reduced.

### First Modification of First Embodiment

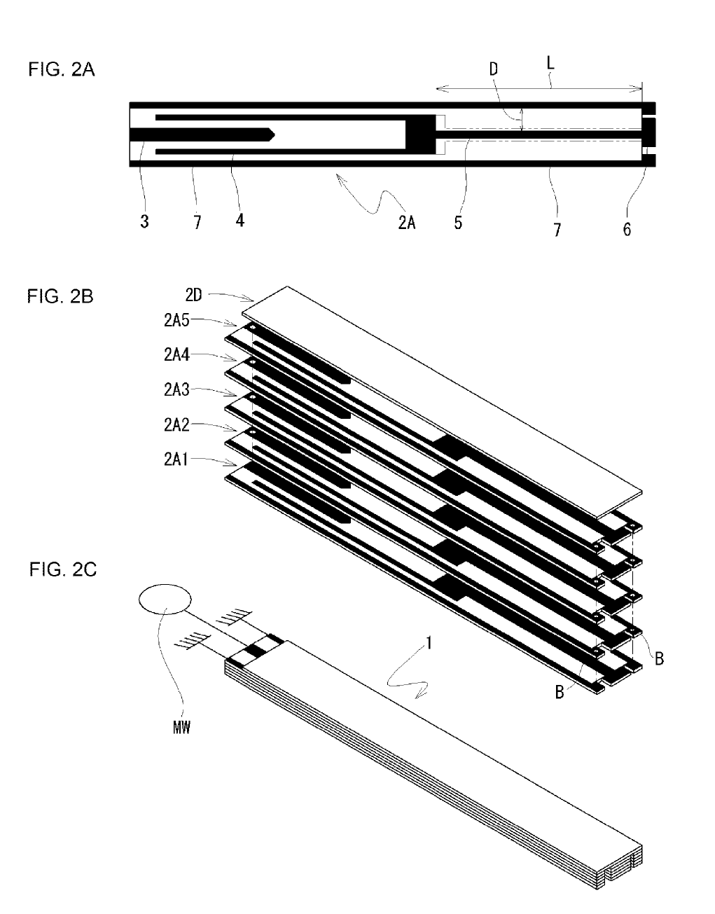

In a first modification of the present first embodiment, a plural sheets of insulating substrates, for example, insulating substrates 2A1 to 2A5, are laminated as illustrated in FIG. 2. The insulating substrate 2 comprises the input electrode 3, the coupling electrode 4, the coupling line 5, the discharge electrode 6, and the ground electrode 7 thereon such that the resonance frequency differs from each other.

The resonance frequency varies also according to an overlapping degree of the input electrode 3 and the coupling electrode 4 or a distance between the coupling electrode 4 and the ground electrode 7, but different resonance frequency is caused by changing the length L of the coupling line 5, and the distance D between the coupling line 5 and the ground electrode 7. Therefore, in this embodiment, the length L of the coupling line 5 and the distance D between the coupling line 5 and the ground electrode 7, as illustrated in FIG. 2(a), are changed into the length and the distance matching a position illustrated by a two dotted line, and thereby, the insulating substrate in which the resonance frequency is different, can be designed.

The insulating substrate 2 of the ignition device 1 can be formed by the above method, but it is desirable to be a thin substrate so as to laminate a plural sheets of insulating substrates 2. Therefore, when formed by, for example, alumina ceramics, original raw powder materials composed of alumina (Al₂O₃) and sintering auxiliary agent (binder, such as SiO2, for example) are mixed with so as to produce a milk-like slurry. By the produced slurry, a ceramic green sheet is formed through a doctor blade method, a calender roll molding method and etc. After then, the input electrode 3, the coupling electrode 4, the coupling line 5, the discharge electrode 6, and the ground electrode 7 are printed through the method of screen printing and etc. by using a conductive paste that is mainly composed of metal powder material such as silver, copper, tungsten, or molybdenum which has a low electrical resistance, and thereby, the insulating substrate 2 is completed.

Regarding respective resonance frequencies of the insulating substrates 2A1 to 2A5, for example, the resonance frequency of the insulating substrate 2A1 is 2.41 GHz, the resonance frequency of the insulating substrate 2A2 is 2.43 GHz, the resonance frequency of the insulating substrate 2A3 is 2.45 GHz, the resonance frequency of the insulating substrate 2A4 is 2.47 GHz, and the resonance frequency of the insulating substrate 2A5 is 2.49 GHz. Further, a variation width is set about between 0.2 and 0.4 GHz (Q factor is about between 61 and 122), and thereby, the discharge can be caused between the discharge electrode 6 and the ground electrode 7 in any one of the insulating substrates 2A1 to 2A5, even if the electromagnetic wave frequency 2.45 GHz oscillated from the electromagnetic wave oscillator MW may fluctuate. Further, each of the resonance frequencies of the insulating substrates 2A1 to 2A5 is set at 2.43 GHz though 2.47 GHz, i.e., the resonance frequency is set to vary per 0.01 GHz basis, and Q factor can be set to about 245. Q factor is the value expressed by:

w0/(w2−w1)

if the resonance frequency of the resonance circuit is w0, and the half energy frequency is respectively w1 and w2 (w1<w2), in which the resonance frequency w0 is sandwiched between w1 and w2.

On the upper surface of the insulating substrate 2A5 on which the electrode surface is exposed, of respective laminated insulating substrates 2A1 to 2A5, as well as the first embodiment, the protection substrate 2D is overlaid so as to cover the electrode surface of the insulating substrate 2A5. Then, heat and pressure are applied to laminate. At that time, an organic binder included in the green sheet functions as a glue for an interlayer connection, and the ignition device 1 with a plural layers of ceramic insulating substrates is completed.

By laminating insulating substrates having different resonance frequencies in order to constitute the ignition device 1, the discharge can be caused with high output power even if frequency of the electromagnetic wave oscillated from the electromagnetic wave oscillator MW may fluctuate.

### <SECOND EMBODIMENT>IGNITION DEVICE

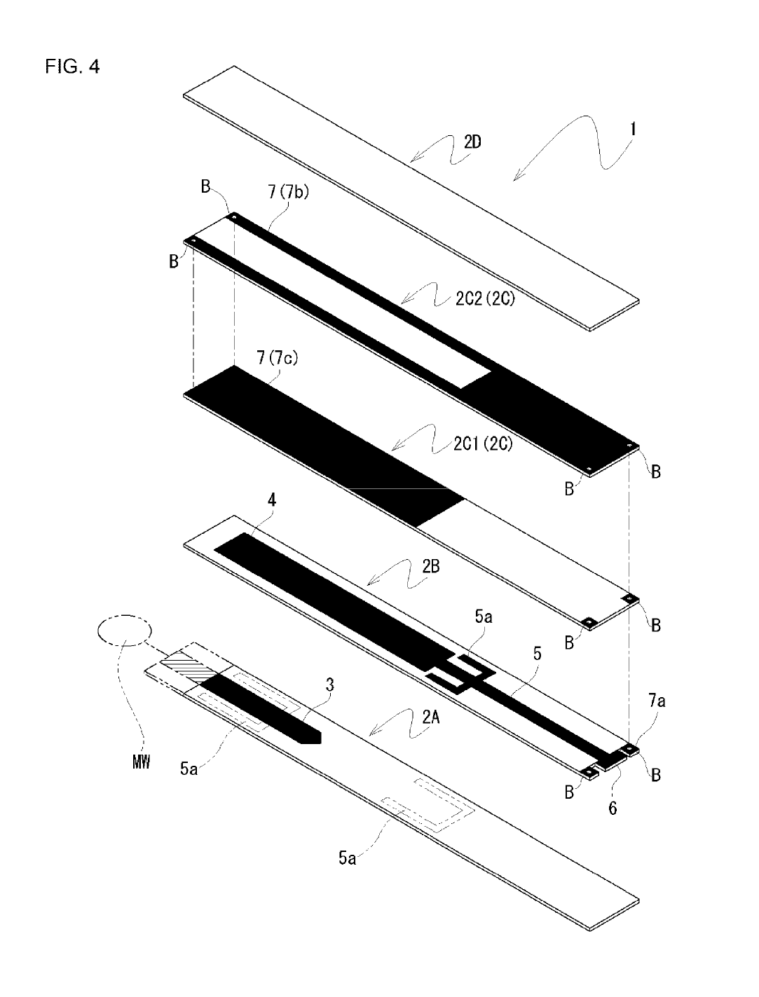

The second embodiment is the ignition device 1 regarding the present invention. As illustrated in FIG. 4, a first rectangular insulating substrate 2A, a second rectangular insulating substrate 2B, and a third rectangular insulating substrate 2C are provided. The first rectangular insulating substrate 2A, on a main surface, includes the input electrode 3 that is connected to the outside terminal at one shorter side. The second rectangular insulating substrate 2B, on the main surface, includes the coupling electrode 4 capacity-coupled with the input electrode 3 of the first rectangular insulating substrate 2A, the discharge electrode 6 connected to the coupling electrode 4 via the coupling line 5 on the other shorter side, and a ground electrode 7a for discharge arranged closely to the discharge electrode 6 on the other shorter side. The third rectangular insulating substrate 2C, on the main surface, includes a ground electrode 7b that is capacity-coupled with the coupling electrode 4 of the second rectangular insulating substrate 2B and capacity-coupled with the coupling line 5, and jointed with the ground electrode 7a for discharge of the second rectangular insulating substrate 2B through a via B for interlayer connection. At least one sheet of each of them, rectangular insulating substrates 2A, 2B, and 2C, are laminated one another, i.e., at least one first rectangular insulating substrate, at least one second rectangular insulating substrate, and at least one third rectangular insulating substrate, are laminated one another. The capacitor formed by the capacity coupling and the inductor formed by the coupling line constitute the resonance circuit, the electromagnetic wave supplied from the outside terminal into the input electrode is resonated, the potential difference between the discharge electrode 6 and the ground electrode 7a for discharge is enhanced, and then the discharge is caused. In the ignition device 1, configuration other than the different printed pattern of electrodes in each of rectangular insulating substrates 2A. 2B, and 2C compared to the first embodiment, is similar with the first embodiment, and the explanation of same configuration is omitted.

The rectangular insulating substrates 2A, 2B, and 2C (in below, referred to “insulating substrates 2A, 2B, and 2C”) of the ignition device 1, as well as the modification of the first embodiment, are composed of ceramics such as, for example, alumina, aluminum nitride, cordierite, or mullite. For example, when the ignition device 1 is constituted of alumina ceramics, original raw powder materials composed of alumina (Al₂O₃) and sintering assistant (binder, such as, SiO2, for example) are mixed with, and milk-like slurry is produced. By using the produced slurry, the ceramic green sheet is formed through the doctor blade method, the calender roll molding method and etc. Then, by using the conductive paste that is mainly composed of metal powder material such as, for example, silver, copper, tungsten, or molybdenum which has the low electrical resistance, the input electrode 3 is printed on the insulating substrate 2A, the coupling electrode 4, the coupling line 5, the discharge electrode 6, and the ground electrode 7a for discharge are printed on the insulating substrate 2B, and the ground electrode 7b jointed with the ground electrode 7a for discharge by the via B for interlayer connection is printed on the insulating electrode 2C through the method of screen printing, etc.

The ignition device 1 provides the input electrode 3 and the coupling electrode 4 that become an equivalent circuit C1 on different insulating substrates, and the breakdown occurrence between the input electrode 3 and the coupling electrode 4 is surely prevented. Furthermore, an impedance matching between the input electrode 3 and the electromagnetic wave oscillator MW and between the coupling electrode 4 and the electromagnetic wave oscillator MW can easily be attained by adjusting the length and the thickness of the input electrode 3 and the coupling electrode 4.

Further, the ground electrode 7 (7c) constituting an equivalent circuit C2 to or from the coupling electrode 4, the ground electrode 7 (7b) constituting an equivalent circuit C3 to or from the coupling line 5, are respectively provided on different insulating substrates 2C. In the present embodiment, the ground electrode 7b and the ground electrode 7c are respectively provided on different insulating substrates 2C2 and 2C1.

The resonance capacitance (stray capacitance) C3 of the equivalent circuit C3 constituted between the ground electrode 7 (7b) and the coupling line 5, as described above, is desired to be formed smaller as much as possible. Therefore, the insulating substrate 2C2 including the ground electrode 7b arranges the insulating substrate 2C1 including the ground electrode 7c to be sandwiched between, and formed such that the ground electrode pattern is not printed between the coupling line 5 and the ground electrode 7b (The equivalent circuit C2 is constituted between the ground electrode 7c and the coupling electrode 4). As a result, the distance between the coupling line 5 and the ground electrode 7b is maintained. Thereby, the resonance capacitance (stray capacitance) C3 can be downsized. Note that, by laminating a plural sheets of insulating substrates 2C1 between the insulating substrate 2B and the insulating substrate 2C2, further downsize of the resonance capacitance (stray capacitance) C3 can be achieved.

Moreover, in order to attain an impedance matching of the circuit, a stub pattern 5a (open stub) can be provided on the coupling line 5 of the insulating substrate 2B. The stub pattern 5a can also be provided on the insulating substrate 2A, and electrically connected with the coupling line 5 of the insulating substrate 2B through the via for interlayer connection (referring to two dotted line at the right side of bottom figure of FIG. 4). By providing the stub pattern 5 on the insulating substrate 2A which has a room area for the pattern printing and only the input electrode 3 is arranged onto, the stub length adjustment can easily be performed.

The stub pattern 5a can also be provided on the input electrode 3 (referring to two dotted line at the left side of bottom figure of FIG. 4). By providing the stub pattern 5a on the input electrode 3 that is positioned at an upstream side of the electromagnetic wave input, the impedance matching can effectively be attained.

Each electrode is formed on the respective insulating substrates 2A through 2C, the protection substrate 2D is overlaid so as to cover the electrode surface on an uppermost surface, and heat and pressure are applied thereon to laminate. At that time, an organic binder included in the green sheet functions as a glue for the interlayer connection, and forming of the ignition device 1 with a plural layers of ceramic insulating substrates is completed.

—Ignition Device Operation—

Regarding the plasma generating operation of the ignition device 1 (ignition operation), as well as the first embodiment, the discharge is caused by the potential difference between the discharge electrode 6 and the ground electrode 7a for discharge, the plasma is generated in the vicinity of the discharge electrode 6 and the ground electrode 7a for discharge (discharger), and then, the injected fuel is ignited.

### Effect of Second Embodiment

The ignition device 1 of the present second embodiment, as well as the first embodiment, can boost the electromagnetic wave, and the discharge can be caused. At that time, the stray capacitance C3 between the coupling line 5 and the ground electrode 7 which is required to be smaller as much as possible among the stray capacitances of the resonance circuit constituting the boosting means, is constituted such that the coupling line 5 and the ground electrode 7 are respectively arranged on different insulating substrates 2B and 2C, and C3 is sufficiently set smaller than the stray capacitance C2 between the coupling electrode 4 and the ground electrode 7 in order to sufficiently boost the supplied electromagnetic wave and obtain high voltage. Thereby, the discharge can be caused between the discharge electrode 6 and the ground electrode 7. Moreover, since the electrode parts that are capacity-coupled with, are not printed on the same substrate together, the discharge in the concerned part can be suppressed.

### <THIRD EMBODIMENT>IGNITION DEVICE

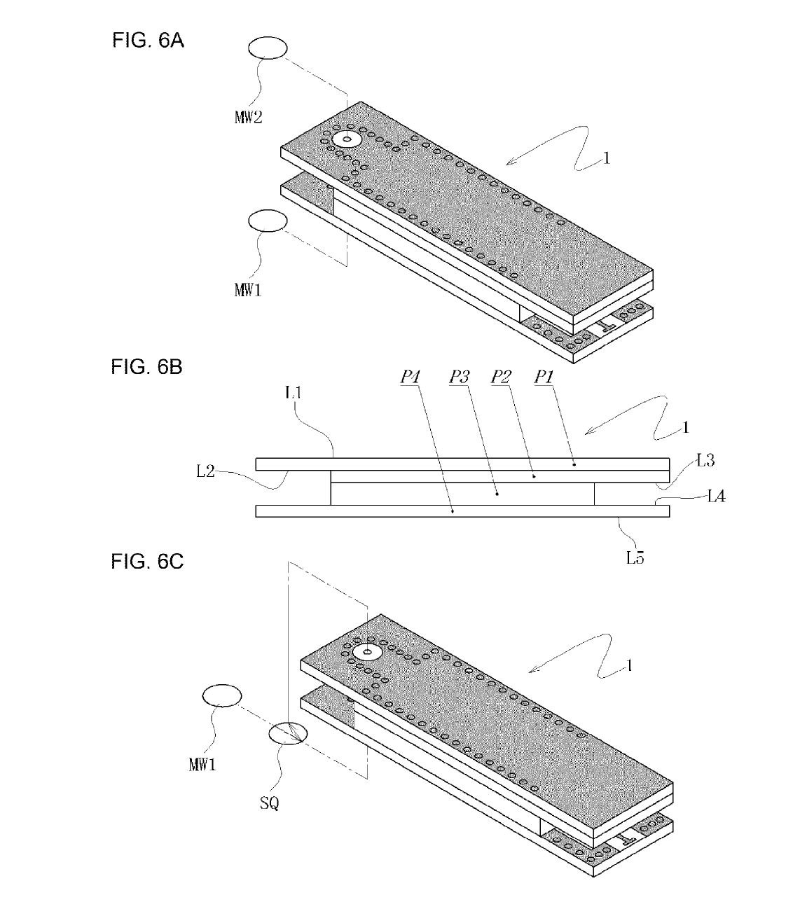

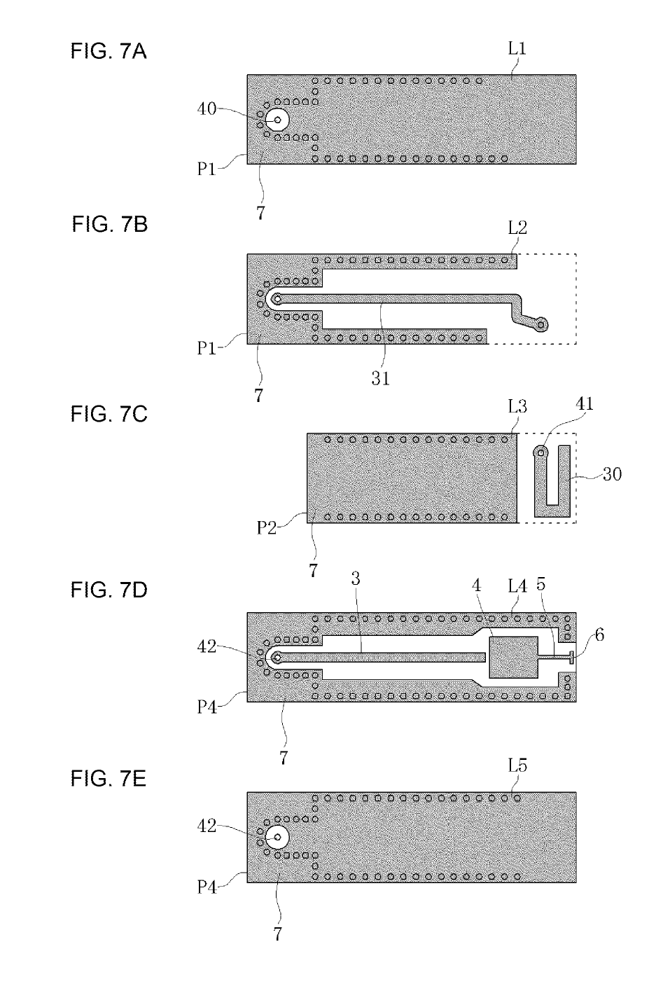

The third embodiment is the ignition device 1 of the present invention. The ignition device 1, as illustrated in FIGS. 6 and 7, is constituted by lamination from first rectangular insulating substrate P1 through fifth rectangular insulating substrate P5. Material for each rectangular insulating substrate is not especially limited; however, as well as the first embodiment, powder material of ceramics (in below, referred to “ceramic material”) such as, for example, alumina (Al₂O₃), aluminum nitride, cordierite, or mullite, is calcined to be molded.

Materials and etc. of each layer (electrode pattern) formed on the main surface (including the back surface) of respective rectangular insulating substrates, are not especially limited, however, as well as the first embodiment, it is configured that the printing is performed on the respective rectangular insulating substrates by using the method, for example, screen printing such that the conductive paste mainly composed of metal powder material such as silver, copper, tungsten, or molybdenum, which has the low electrical resistance, matches with the shape of each layer, electrode pattern (referring to FIG. 7(a) to FIG. 7(e)).

The layers (electrode patterns) forming respective rectangular insulating substrates (in below, referred only to “substrate”) are explained. The layer L1 on the main surface of a first substrate P1 includes the ground electrode 7 and a via 40 for connecting to an antenna line 31. The layer L2 on the back surface of the first substrate P1 includes the antenna line 31 that is continuous from the via 40. The via 40 is connected to the electromagnetic wave oscillator MW2 through a coaxial cable, for example.

The printing of the layer (electrode pattern) is not performed on the main surface of a second substrate P2, and the via 40 continuous to one end of an antenna 30 on the back surface is formed. The layer (electrode pattern) L3 on the back surface of the second substrate P2 includes the antenna 30 continuous from the via 40.

Fourth substrate P4 on the main surface has a similar configuration with the first embodiment. The substrate P4 includes the input electrode 3, the coupling electrode 4, the discharge electrode 6, and the ground electrode 7. The input electrode 3 is connected to the outside terminal in the vicinity of one shorter side. The coupling electrode 4 is capacity-coupled with the input electrode 3. The discharge electrode 6 is connected to the coupling electrode 4 on the other shorter side via the coupling line 5. The ground electrode 7, on both the longer sides, is capacity-coupled with the coupling electrode 4 and capacity-coupled with the coupling line 5, and forms a predetermined gap between the ground electrode 7 and the discharge electrode 6 on the other shorter side. At a point connected to the outside terminal in the neighborhood of one shorter side, a via 42 continuous to the back surface is formed. Note that, a positional relationship between the input electrode 3 and the coupling electrode 4 may be the relationship illustrated in FIG. 1(a). The via 42 is connected to the electromagnetic wave oscillator MW1 via a coaxial cable, for example.

Third substrate functions as a spacer for spacing a predetermined distance between the discharge electrode 6 formed on the main surface of the fourth substrate P4 and the antenna 30 formed on the back surface of the second substrate P2. The ignition device of the present embodiment is configured by providing a predetermined thickness as the spacer to the protection substrate 2D of the first embodiment and, on the upper part thereof, laminating the substrate formed with an antenna configured to supply energy into the discharger.

The resonance structure and the boosting means are similar to the first embodiment, and the explanation is omitted. Further, as well as the first embodiment, the substrate between the discharge electrode 6 and the ground electrode 7 may be notched in order to form a notching portion.

In the above configuration, firstly, a controller (not illustrated) outputs an electromagnetic wave oscillating signal at a predetermined frequency f regarding the ignition operation of the ignition device 1, as well as the first embodiment. The signal is outputted according to a crank angle of the internal combustion engine (usually, before the top dead center (BTDC) on compression stroke). The electromagnetic wave oscillator MW1 that receives power from an electromagnetic wave source (not illustrated), when receives such an electromagnetic wave oscillating signal, outputs an electromagnetic wave pulse at a frequency f with a predetermined duty ratio over a predetermined set time. The electromagnetic wave pulse outputted from the electromagnetic wave oscillator MW1 becomes a high voltage by the boosting means of the ignition device 1 which has the resonance frequency f. The mechanism in which the electromagnetic wave becomes the high voltage is achieved, as described above, because it is configured such that the resonance capacitance (stray capacitance) C2 is sufficiently larger than C3, and it is configured such that the stray capacitance C3 between the coupling line 5 and the ground electrode 7, the stray capacitance C2 between the coupling electrode 4 and the grounding electrode 7, and a coil corresponding to an equivalent circuit L1 of the coupling line 5 form a resonance circuit. Then, boosted electromagnetic wave enhances the potential difference between the discharge electrode 6 and the ground electrode 7, the discharge is caused, and the spark is generated. The electromagnetic wave (microwave) oscillated from the electromagnetic wave oscillator MW2 is irradiated from the antenna 30 into the discharge plasma, the energy is supplied into the discharge plasma, and unbalanced plasma, i.e., non local thermodynamic equilibrium plasma is maintained and expanded.

### Effect of Third Embodiment

A substrate circuit for generating a discharge plasma and an antenna circuit for supplying the electromagnetic wave as an energy into the discharge plasma are formed in one laminated circuit, and thereby, the fuel ignition significantly becomes volumetric ignition, the ignition is surely performed, and an ignition efficiency can significantly be improved, even if the device is a small-sized ignition device.

### First Modification of Third Embodiment

In a first modification of the third embodiment, as illustrated in FIG. 6(c), a reflected wave of the electromagnetic wave supplied from the electromagnetic wave oscillator MW1 into the discharge electrode 3 is used as the electromagnetic wave supplied as energy into the discharge plasma. Specifically, a circulator SQ that connects a first port to the electromagnetic wave oscillator MW1, connects a second port to the via 43, and connects a third port to the via 40, is interposed between the electromagnetic wave oscillator MW1 and the input electrode 3, and the reflected wave generated after the discharge is supplied into the antenna 30 via the third port.

### INDUSTRIAL APPLICABILITY

As described as above, the ignition device of the present invention is an ignition device with a smaller diameter and a reduced thickness that can boost an electromagnetic wave, and can cause discharge. Arranging position thereof is significantly freely selected, and it can be used to various types of internal combustion engines. The ignition device can be used by adding on an injector of an internal combustion engine based on gasoline engine, diesel engine, which uses as fuel, natural gas, coal mine gas, shale gas and etc., specifically, an internal combustion engine based on diesel engine, which uses as fuel, gas (CNG gas or LPG gas), from a viewpoint of fuel consumption improvement and environmental improvement.

### NUMERAL EXPLANATION

1 Ignition Device
2 Insulating Substrate
3 Input Electrode
4 Coupling Electrode
5 Coupling Line
6 Discharge Electrode
7 Grounding Electrode

1. An ignition device comprising:
a rectangular insulating substrate having a main surface;
an input electrode provided on the main surface of the rectangular insulating substrate and connected to an outside terminal on one shorter side of the rectangular insulating substrate;
a coupling electrode provided on the main surface of the rectangular insulating substrate and capacity-coupled with the input electrode;
a discharge electrode provided on the main surface of the rectangular insulating substrate and connected to the coupling electrode on the other shorter side of the rectangular insulating substrate through a coupling line; and
a ground electrode provided on the main surface of the rectangular insulating substrate and capacity-coupled with the coupling electrode and capacity-coupled with the coupling line on both longer sides of the rectangular insulating substrate, and extended to the other shorter side,
wherein the ignition device has a resonance circuit constituted by a capacitor formed by the capacity coupling and an inductor formed by the coupling line, is configured to resonate an electromagnetic wave that is supplied from the outside terminal into the input electrode, and is configured to cause a discharge by enhancing a potential difference between the discharge electrode and the ground electrode.

2. An ignition device comprising:
at least one first rectangular insulating substrate; at least one second rectangular insulating substrate; and at least one third rectangular insulating substrate, which are laminated one another, wherein
the first rectangular insulating substrate has a main surface on which an input electrode is connected to an outside terminal on one shorter side of the first rectangular insulating substrate;
the second rectangular insulating substrate having a main surface on which a coupling electrode, a discharge electrode, and a ground electrode for discharge are provided, the coupling electrode being capacity-coupled with the input electrode, the discharge electrode being connected to the coupling electrode on the other shorter side of the second rectangular insulating substrate through a coupling line, and the ground electrode for discharge being arranged in a vicinity of the discharge electrode on the other shorter side; and
the third rectangular insulating substrate having a main surface on which a ground electrode is capacity-coupled with the coupling electrode and capacity-coupled with the coupling line, and jointed with the ground electrode for discharge through a via for an interlayer connection, and
the ignition device has a resonance circuit constituted by a capacitor formed by the capacity coupling and an inductor formed by the coupling line, is configured to resonate an electromagnetic wave that is supplied from the outside terminal into the input electrode, and is configured to cause the discharge by enhancing a potential difference between the discharge electrode and the ground electrode.

3. The ignition device according to claim 1,
wherein a plurality of said rectangular insulating substrates, each provided with the input electrode, the coupling electrode, the coupling line, the discharge electrode, and the ground electrode, are laminated and configured such that a resonance frequency of each resonance circuit differs from one another.

4. The ignition device according to claim 3,
wherein the different resonance frequencies are caused by adjusting a length of the coupling line, and a distance between the coupling line and the ground electrode.

5. The ignition device according to claim 1,
wherein a ground electrode pattern is provided on the whole main surface of the rectangular insulating substrate, and jointed with the ground electrode through a via for an interlayer connection.

6. The ignition device according to claim 1,
wherein the rectangular insulating substrate has a notched portion formed between the discharge electrode and the ground electrode on the other shorter side.
